(19) United States
(12) Patent Application Publication
(10) Pub. No.: US 2009/0152869 A1
(43) Pub. Date: Jun. 18, 2009

(54) Economical method of power generation from solar heat

(76) Inventor: David R. Zarrin, Torrance, CA (US)

Correspondence Address: EDWARD C. SCHEWE, 1600 Rosecrans Avenue, Fourth Floor, MANHATTAN BEACH, CA, 90266, US

(21) Appl. No.: 12/001,447

(22) Filed: Dec. 12, 2007

(51) Int. Cl. F03B 13/00; F03G 6/00

(52) U.S. Cl. 290/52; 60/641.8; 290/1 R

(57) ABSTRACT

An apparatus for converting solar heat into electrical power by building a large structure with a transparent roof at the edge of any steep high mountain having a large diameter pipe connected to the roof at the top end of the structure and laid on the surface of the mountain to the top of the mountain. A fan-operated turbine-generator installed at the bottom base of the large diameter pipe generates electricity. The invention includes constructing shallow pools or reservoirs inside the structure, storing the moisture generated via humid air and condensation at the top of the mountain in a pool or water tank, installing a return pipe to the original reservoirs or pools, and installing a hydro-electric turbine-generator at the bottom of the mountain on this return pipe to generate additional electricity.

### BACKGROUND OF THE INVENTION

1. Field of Invention

The present invention relates to one of the most economical system to convert solar energy to electrical power. This invention utilizes the concept of air pressure differential to generate high-speed air-travel; in order to operate a fan operated turbine-generator.

2. Description of Prior Invention

U.S. Pat. No. 4,275,309 utilizes this concept by constructing a large structure with a transparent roof and a large diameter tower at the middle of the structure. The air inside the structure is heated by the sun and sucked into the tower at high speed. The air speed would operate a fan-operated turbine-generator installed at the base of the tower.

### SUMMARY OF THE INVENTION

The current invention utilizes the same concept by constructing a large structure, with transparent roof, at the edge of any steep high mountain. A large diameter pipe, laid on the surface of the mountain, from the roof at the high edge of the structure to the top of the mountain. The roof and walls of the structure is built of glass or any transparent material capable of transmitting the solar rays into the structure. The sunlight heats up the ground under the structure, generating enormous amount of heat, and heating the air inside the structure. The value of the pressure differential is dependent on the altitude and steepness of the mountain. The higher the altitude of the mountain, the higher the air pressure differential would be. The steepness of the mountain has to be very high in order to generate high air speed.

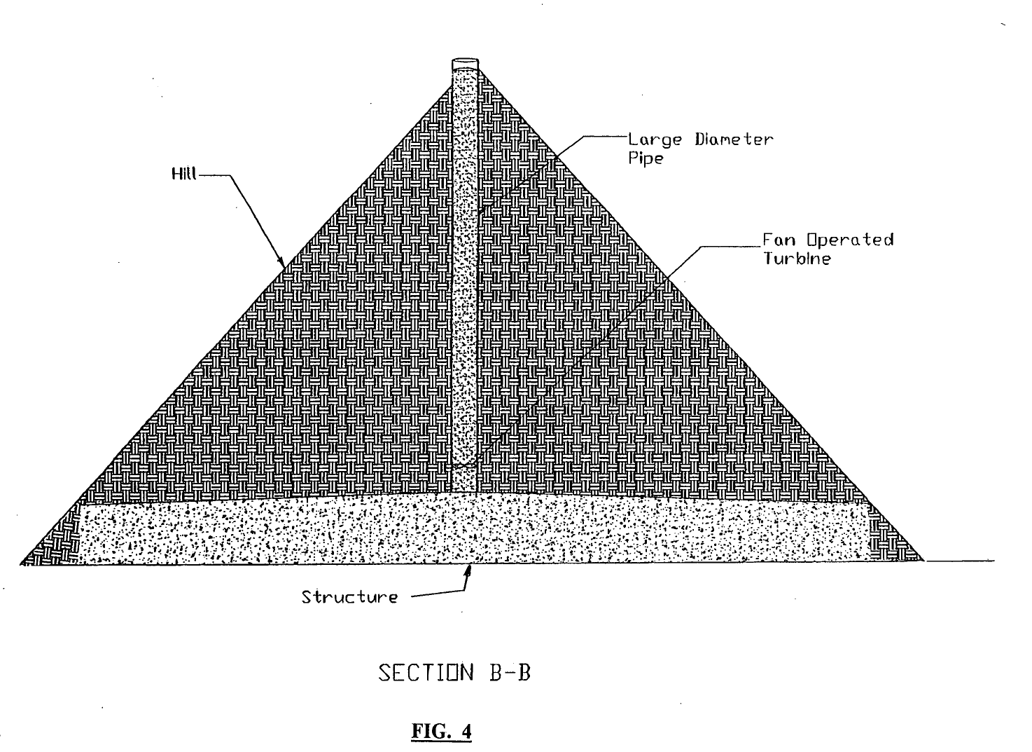

The pipe's materials and thickness has to be designed to withhold against environmental conditions for the life of the power plant. The degree of insulation has to be determined by the engineers. Obviously, due to high speed, a limited insulation is adequate. For better support, the pipe can be partially embedded into the surface of the mountain, as shown in FIG. 4.

A fan-operated turbine-generator is installed at the base of the high diameter pipe. There are existing fan-operated turbine-generators designed and available in the market for this application. An air inlet has to be installed on the wall of the structure. The location of the air inlet has to at ground level, sized equivalent to the air outlet at the roof. A number of fans have to be installed inside the structure for air circulation.

The major advantage of this invention compared to U.S. Pat. No. 4,275,309 is in cost, effectiveness in relation to the electrical power generated. The cost of installing a high diameter pipe on the surface of a stable mountain is much lower than constructing a very high tower. Another clear advantage is in the cost of the structure. The height of the structure roof built in a flat area increases from the edge to the center of the structure. In this invention, the roof elevation follows the natural ground elevation and is naturally elevated toward the top end of the structure. Therefore, the average height of the structure in this invention is much lower than in U.S. Pat. No. 4,275,309. Therefore, the cost to build the structure per square-foot is much lower in this invention.

Depending on the cost effectiveness, additional energy can be generated as by-product of this invention. If shallow reservoirs or pools were constructed inside the enclosed structure, the heated air would become highly humid. This moisture can be inverted into water due to condensation on the top of the mountain. This water can be stored in a pool, or a large water tank and returned to the structure pools via a pipeline. Additional electricity can be generated via installation of a hydroelectric turbine generator on this pipeline. Needless to say, this additional electricity can be generated at the middle of afternoon hours when the demand on the power grids are very high by releasing this power and operating the hydro electric generator during the hours of high demand. If this invention is built in humid areas similar to Eastern States of America, the idea of additional energy through condensation can be more seriously considered.

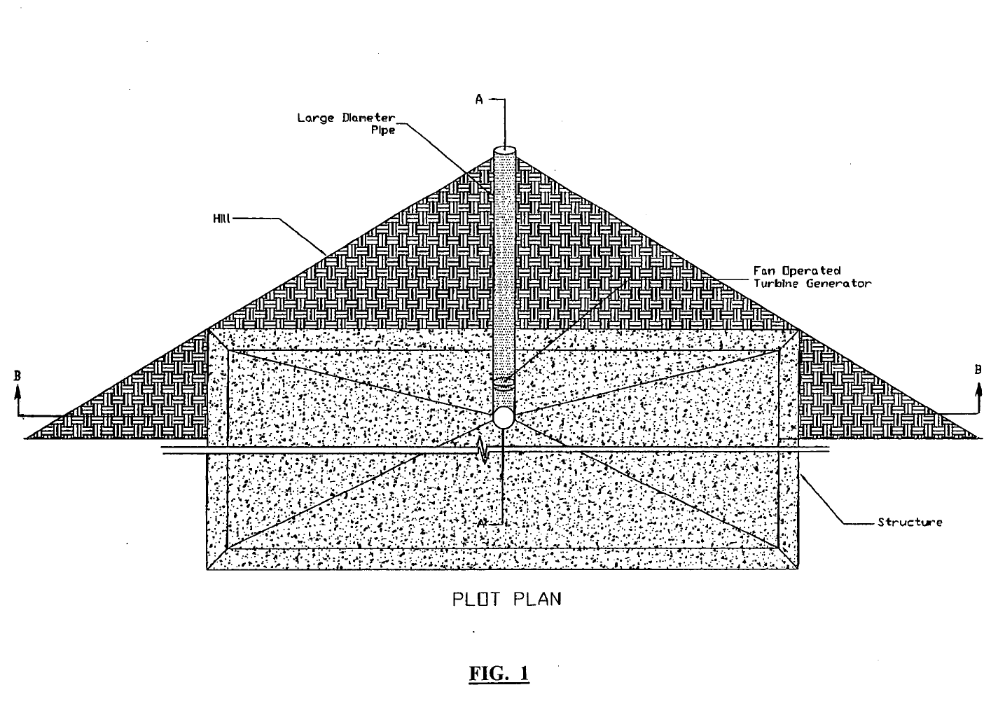

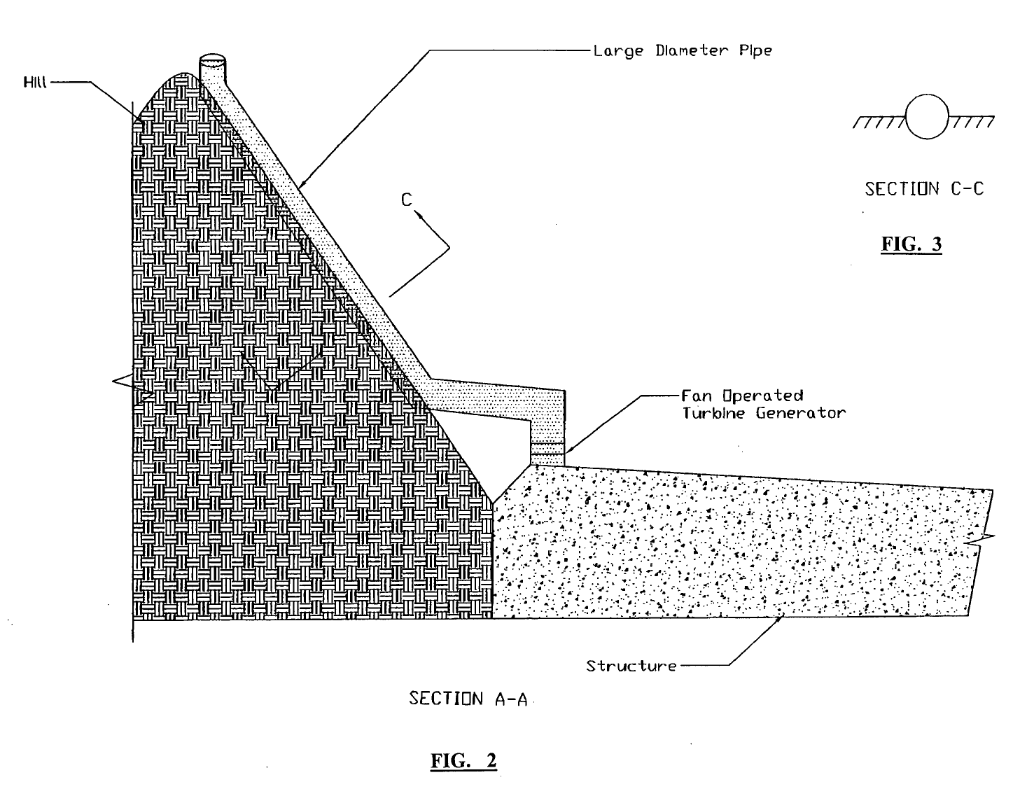

The attached drawings FIG. 1, FIG. 2, FIG. 3, and FIG. 4, consisting of Plot Plan, Section A-A, Section B-B, and Section C-C are drawn to describe this invention.

1. An apparatus for economically converting solar heat into electrical power can be constructed by building a large structure with a transparent roof at the edge of any steep high mountain with a large diameter pipe connected to the roof at the top end of the structure and laid on the surface of the mountain to the top of the mountain. A fan-operated turbine-generator can be installed at the bottom base of the large diameter pipe to generate electricity without any fuel cost.

2. The apparatus of claim 1, can economically generate enormous amount of electricity without any fuel cost.

3. The apparatus of claim 1, can be built at the edge of any steep high mountain in hot sunny areas. Many such locations are available within the Western States of America.

4. The apparatus of claim 1, can be built with much lower initial cost than any other inventions utilizing the same principal. The cost of the structure with the transparent roof is lower because of the lower height of the structure in comparison with the other inventions. The cost of the pipe laid on the surface of the mountain is also lower than a tower built to achieve the same result.

5. The apparatus of claim 1, can generate additional electricity as a by-product of this invention by a) constructing shallow pools or reservoirs inside the structure, and b) storing the moisture generated via humid air and condensation at the top of the mountain in a pool or water tank, and c) installing a return pipe to the original reservoirs or pools, and d) installing a hydroelectric turbine-generator at the bottom of the mountain on this return pipe to generate this additional electricity. This additional electricity can be utilized when the demand of power grids are high by operating this generator through return pipe at the middle of afternoons.
